(19) United States
(12) Patent Application Publication
(10) Pub. No.: US 2005/0124239 A1
(43) Pub. Date: Jun. 9, 2005

(54) System and method for reinforcing wallboard

(76) Inventor: Waymon B. Griner JR., Plantation, FL (US)

Correspondence Address: BRINKLEY, MCNERNEY,;MORGAN, SOLOMON & TATUM LLP, SUITE 1900, 200 E. LAS OLAS BLVD., FORT LAUDERDALE, FL, 33301, US

(21) Appl. No.: 10/728,193

(22) Filed: Dec. 4, 2003

(51) Int. Cl. B32B 27/12; B32B 27/04; B32B 5/26; B32B 17/02; B32B 17/12; B32B 5/02

(52) U.S. Cl. 442/24; 442/20; 442/43; 442/45

(57) ABSTRACT

A system for reinforcing wallboard (15) used to form a wall or ceiling (10) of a building includes two scrim layers (20, 30) and two skimcoat layers (25, 35). The first scrim layer is attached (e.g., through use of fasteners (17)) to a surface of the wallboard. The first skimcoat layer is disposed on the first scrim layer to form a first reinforcement layer attached to and covering the wallboard. The second scrim layer is attached (e.g., also through use of fasteners) to the first skimcoat layer. The second skimcoat layer is disposed on the second scrim layer to form a second reinforcement layer attached to and covering the wallboard. The two reinforcement layers interact to reinforce the wallboard rendering it less susceptible to chipping or other damage. A finishing layer (40), such as an acrylic coating, may optionally be applied to the second skimcoat layer for decorative purposes.

### FIELD OF THE INVENTION

The present invention relates generally to the manufacturing and repair of composite materials used to form walls and/or ceilings of buildings and, more specifically, to a system and method of reinforcing conventional wallboard utilizing a series of scrim reinforcing layers.

### BACKGROUND OF THE INVENTION

Wallboard materials, such as drywall, are well known in the art. Such materials are commonly used in both commercial and residential buildings and are easily broken, chipped, cracked, or otherwise, damaged, particularly in commercial settings. Previous attempts to replace drywall with a different surfacing material and/or repair damaged areas of wall and/or ceiling surfaces can be found in the art. One such attempt is described in U.S. Pat. No. 5,620,768 issued to Hoffman (“the '768 Patent”).

The '768 Patent describes a wall patch formed by an inner mesh layer, a smaller reinforcing sheet, and an outer mesh layer having dimensions similar to the inner mesh layer. The inner surface of the inner mesh layer is coated with a pressure-sensitive adhesive that enables the inner mesh layer to adhere to the drywall. The inner surface of the outer mesh layer is also coated with a pressure-sensitive adhesive that enables the outer portion of the outer mesh layer to adhere to the inner mesh layer and the smaller reinforcing sheet, thereby encasing the reinforcing sheet between the mesh layers. By pre-coating the inside surfaces of the mesh layers with pressure-sensitive adhesive, there is no need to apply adhesive to the reinforcing sheet. The reinforcing sheet is preferably perforated to enable the adhesive on the inner surface of the outer mesh layer to penetrate through the apertures in the reinforcing sheet to provide more adhesion between the mesh layers. While the wall patch disclosed in the '768 Patent may be adequate for quickly repairing small areas of a wall, it is not readily useful for reinforcing large sections of walls or ceilings due to, among other things, the difficulty in applying sufficient pressure to the mesh layers to activate the pressure-sensitive adhesives.

An attempt at restoring large damaged areas of plaster walls and/or ceilings is described in U.S. Pat. No. 4,662,144 issued to Rogers (“the '144 Patent”). The restoration method described in the '144 Patent consists of first cleaning away peeled plaster and paint until a surface of solid plaster is established. Next, a liquid alkyd sealer is applied to the area to be resurfaced. The sealer serves as a binder and a moisture barrier. After the sealer has completely dried (about 24 hours), a first coat of conventional joint compound is applied to a portion of the damaged area of plaster directly over the dried sealer. A screen is then pressed into the joint compound and against the damaged area of plaster. Excess joint compound is then removed with a trowel and the joint compound is allowed to completely dry (typically another 24 hours). A second coat of joint compound is then applied over the screen and the first layer of joint compound as a finishing layer to fill the interstices of the screen and provide a smooth surface finish. After the second coat of joint compound has dried, a decorative finish may be applied to the repaired wall.

As evident from the foregoing, the methodology disclosed in the '144 Patent applies only to repairing damaged areas of plaster walls. As a result, such method is not readily useful for repairing or reinforcing other forms of wallboard. In addition, due to its requirement of applying three layers of materials that must be dried over 24 hour periods, the process described in the '144 Patent is extremely time consuming.

U.S. Pat. No. 2,162,658 issued to Wieslander (“the '658 Patent”) describes a method to repair cracked areas of a plaster ceiling in lieu of replacing the entire ceiling. The reconstruction system described in the '658 Patent consists of first using large-headed nails or screws to secure loose edges of plaster to laths or floor timbers and then applying and working in a cohesive plastic material in a thickness and manner that will ensure complete coverage of all unevenness of the original plastering and any newly-introduced nail or screw heads. Next, metal mesh sheets are pressed into the partially dried, cohesive plastic material to cover the damaged area, such that the plastic material extrudes through the mesh sheet apertures. A second layer of cohesive plastic material is then applied to bind to the extruded sections of the first plastic layer and form a smooth surface ready for finishing with paint or other finishing materials. This system has limited application in that it only relates to repair of damaged areas of plaster ceilings and does not provide for reinforcing an entire wall or ceiling, regardless of existing damage.

Other attempts to replace drywall with a different surfacing material and/or repair damaged areas of wall and/or ceiling surfaces are described in U.S. Pat. No. 5,925,204 to Hoffman, U.S. Pat. No. 4,135,017 to Hoffman, U.S. Pat. No. 3,044,919 to Stoneburner, U.S. Pat. No. 5,839,241 to Cacossa, and U.S. Pat. No. 5,649,398 to Isley. However, none of the devices, systems, and/or methods disclosed therein are practical for use in reinforcing entire wall and/or ceiling surfaces sufficiently enough to resist damage. Therefore, a need exists for a composite wall material, wallboard reinforcement system, and method of installation and/or manufacture that facilitates use on and reinforcement of entire wall and/or ceiling surfaces, without being limited to use on plaster wallboard and without requiring an inordinate amount of time to be installed.

### BRIEF DESCRIPTION OF THE DRAWINGS

The specification uses the following figures to illuminate the preferred embodiments of the present invention. However, it is to be understood that the invention is not intended to be limited to the embodiments shown, which are merely exemplary and not by way of limitation.

FIG. 1 is a top plan cutaway view of a composite material for use in forming a wall or ceiling of a building in accordance with a preferred embodiment of the present invention.

FIG. 2 is an exploded perspective view of a system for reinforcing wallboard used to form a wall or ceiling of a building in accordance with a preferred embodiment of the present invention.

FIG. 3 is a flow chart of steps for reinforcing wallboard used to form a wall or ceiling of a building in accordance with a preferred embodiment of the present invention.

### DETAILED DESCRIPTION OF A PREFERRED EMBODIMENT

Generally, the present invention encompasses a system and method for reinforcing wallboard used to form a wall or ceiling of a building. The system includes two reinforcement layers attached to a surface of the wallboard. The first reinforcement layer includes a first scrim layer and a first skimcoat layer disposed on the first scrim layer. In a preferred embodiment, the first scrim layer is secured to the surface of the wallboard using a set of fasteners, such as staples, nails or screws, and the first skimcoat layer is applied to and disposed on the fastened scrim layer. The second reinforcement layer is attached to the first reinforcement layer, preferably after the first skimcoat layer has at least partially dried, and includes a second scrim layer and a second skimcoat layer disposed on the second scrim layer. The skimcoat layers are preferably formed using joint compound, plaster, or acrylic compound. A finishing layer, such as an acrylic coating, paint, wallpaper, paneling or tile, is optionally disposed on the dried second skimcoat layer for decorative purposes.

The reinforcement system, is preferably attached to the wallboard on site, after the wallboard has been installed to form the walls and/or ceilings of a building. Alternatively, the reinforcement system may be attached to the wallboard prior to installation of the wallboard to form a composite material for use in forming a wall or ceiling of a building.

By reinforcing wallboard in this manner, the present invention facilitates reinforcement of entire wall and/or ceiling surfaces, without being limited to use on plaster wallboard, requiring an inordinate amount of time to be installed and merely repairing damaged sections of wallboard. Thus, in contrast to prior art wallboard repair procedures, the present invention provides a system for reinforcing wallboard such that the reinforced wallboard can withstand the demands of commercial environments.

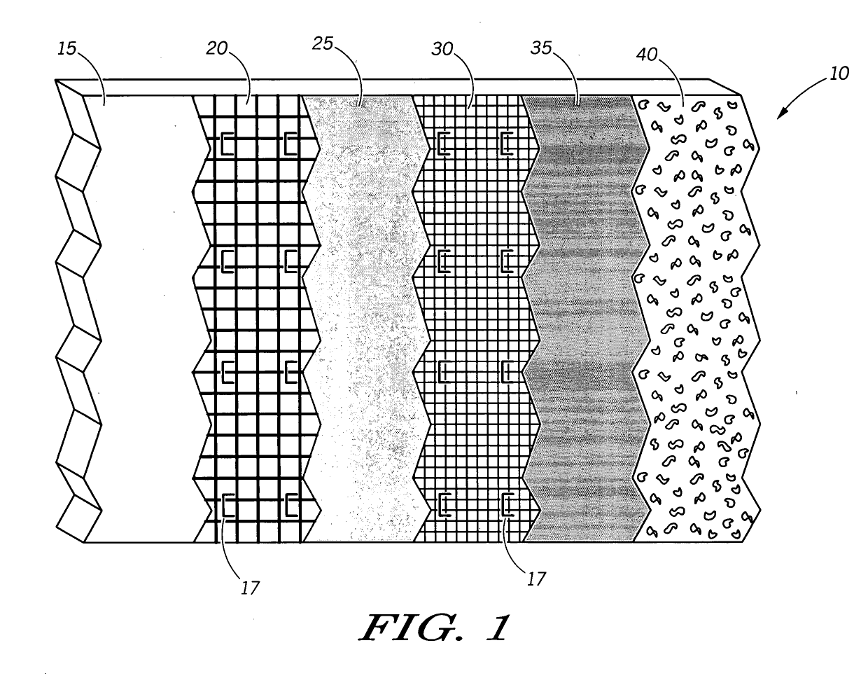

The present invention can be more fully understood with reference to FIGS. 1-3, in which like reference numerals designate like items. FIG. 1 is a top plan cutaway view of a composite material 10 for use in forming a wall or ceiling of a building in accordance with a preferred embodiment of the present invention. The preferred composite material 10 includes six (6) interconnected layers. The first layer is a layer or sheet of wallboard 15 having a predetermined thickness (e.g., one-half inch or five-eighths inch). The wallboard 15 may be any conventional wallboard, such as drywall, plaster, or lath.

A first mesh or scrim layer 20 is attached to a surface of the wallboard 10 preferably through the use of fasteners, such as staples 17, nails, screws, or tacks. Alternatively, the first scrim layer 20 may be attached to the wallboard 15 by applying an adhesive or acrylic compound to the surface of the wallboard 15 and pressing the first scrim layer 20 against the adhesive or compound, or pre-coating the first scrim layer 20 with a pressure-sensitive adhesive and pressing the pre-coated scrim layer 20 against the wallboard surface. One of ordinary skill in the art will readily recognize and appreciate that various other techniques for attaching the first scrim layer 20 to the wallboard 15 may be alternatively employed.

The first scrim layer 20 may be fabricated from any conventional reinforcing material, such as fiberglass, plastic, nylon, steel, or aluminum, and may be woven or non-woven. In a preferred embodiment, the first scrim layer 20 is crosshatched and fabricated from yarns of Glass Mesh Fabric EC fiberglass scrim, which is commercially available from Bonsal American, Inc. of Charlotte, N.C. The first scrim layer 20 has a weight preferably in the range of 14 to 22 ounces per square yard and preferably includes a yarn count in the range of approximately 4×4 to 7×7 yarns per square inch (optimally 5×5 yarns per square inch), wherein each yarn has a width in the range of approximately 1/16 to ⅛ inches. Other yarn counts, weights, and widths may be alternatively employed depending on the desired strength and durability of the reinforcement layer formed from the combination of the first scrim layer 20 and the first skimcoat layer 25.

A first skimcoat layer 25 is applied to and disposed on the first scrim layer 20. Such application preferably occurs after the first scrim layer 20 has been fastened or otherwise attached to the surface of the wallboard 15. Alternatively, the first scrim layer 20 may be optionally pre-coated with the first skimcoat layer 25 to form a composite layer that is attached to the surface of the wallboard 15. As noted above, the first scrim layer 20 and the first skimcoat layer 25 collectively form a first reinforcement layer. The first skimcoat layer 25 is preferably fabricated by applying a mud or cement-like material, such as plaster, joint compound, clay, or acrylic surfacing compound, over the first scrim layer 20 using a trowel or similar applicator. The first skimcoat layer 25 preferably comprises an acrylic surfacing compound, such as the SKIMM joint and surfacing compound that is commercially available from Triarch Industries, Inc. of Houston, Tex. The applied material forming the first skimcoat layer 25 preferably penetrates the apertures or perforations in the first scrim layer 20 contacting and adhering to the wallboard 15. Upon completion of applying the material forming the first skimcoat layer 25, such skimcoat layer 25 is preferably just thick enough to completely encase the first scrim layer 20 and provides a substantially level and smooth exposed surface.

The next layer is the second scrim or mesh layer 30, which is attached to the exposed surface of the first skimcoat layer 25 wallboard 10 preferably through the use of fasteners, such as staples 17, nails, screws, or tacks. Alternatively, the second scrim layer 30 may be attached to the first skimcoat layer 25 by applying an adhesive or acrylic compound to the dried first skimcoat layer 25 and pressing the second scrim layer 30 against the adhesive or pre-coating the second scrim layer 30 with a pressure-sensitive adhesive and pressing the pre-coated scrim layer 30 against the dried first skimcoat layer 25. One of ordinary skill in the art will readily recognize and appreciate that various other techniques for attaching the second scrim layer 30 to the first skimcoat layer 25 may be alternatively employed.

The second scrim layer 30 may be fabricated from any conventional reinforcing material, such as fiberglass, plastic, nylon, steel, or aluminum, and may be woven or non-woven. In a preferred embodiment, the second scrim layer 30, like the first scrim layer 20, is crosshatched and fabricated from yarns of Glass Mesh Fabric EC fiberglass scrim, which is commercially available from Bonsal American, Inc. of Charlotte, N.C. Alternatively, the second scrim layer 30 may be fabricated from a different material than is used to fabricate the first scrim layer 20.

In contrast to the first scrim layer 20, the second scrim layer 30 has a weight preferably in the range of 4 to 15 per square yard and preferably includes a yarn count in the range of approximately 6×6 to 10×10 yarns per square inch (optimally 7×7 yarns per square inch), wherein each yarn has a width in the range of approximately 1/32 to 1/16 inches. Therefore, the yarn widths of the material forming the rows and columns of the first scrim layer 20 are preferably greater than the yarn widths of the material forming the rows and columns of the second scrim layer 30. Similarly, the weight per square yard of the material forming the first scrim layer 20 is preferably greater than the weight per square yard of the material forming the second scrim layer 30. On the other hand, the yarn count per square inch of the material forming the first scrim layer 20 is preferably less than the yarn count per square inch of the material forming the second scrim layer 30. Other yarn counts, weights, and widths of the material forming the second scrim layer 30 may be alternatively employed depending on the desired strength and durability of the reinforcement layer formed from the combination of the second scrim layer 30 and the second skimcoat layer 35.

The second skimcoat layer 35 is applied to and disposed on the second scrim layer 30. Such application preferably occurs after the second scrim layer 30 has been fastened or otherwise attached to the first skimcoat layer 25 and/or the wallboard 15. Alternatively, the second scrim layer 30 may be optionally pre-coated with the second skimcoat layer 35 to form a composite layer that is attached to the first skimcoat layer 25. As noted above, the second scrim layer 30 and the second skimcoat layer 35 collectively form a second reinforcement layer.

Similar to the first skimcoat layer 25, the second skimcoat layer 35 is preferably fabricated by applying a mud or cement-like material, such as plaster, joint compound, clay, or acrylic compound, over the second scrim layer 30 using a trowel or similar applicator. The second skimcoat layer 35 preferably comprises the same material as is used to fabricate the first skimcoat layer 25 (e.g., an acrylic compound), although any suitable cement-like material may be used. The applied material forming the second skimcoat layer 35 preferably penetrates the apertures or perforations in the second scrim layer 30 contacting and adhering to the first skimcoat layer 25. Upon completion of applying the material forming the second skimcoat layer 35, such skimcoat layer 35 is preferably just thick enough to completely encase the second scrim layer 30 and provides a substantially level and smooth exposed surface. The second skimcoat layer 35 is preferably disposed on the second scrim layer 30 after the first skimcoat layer 25 has at least partially dried or set (approximately eight hours depending on the physical properties of the material selected to form the first skimcoat layer 25).

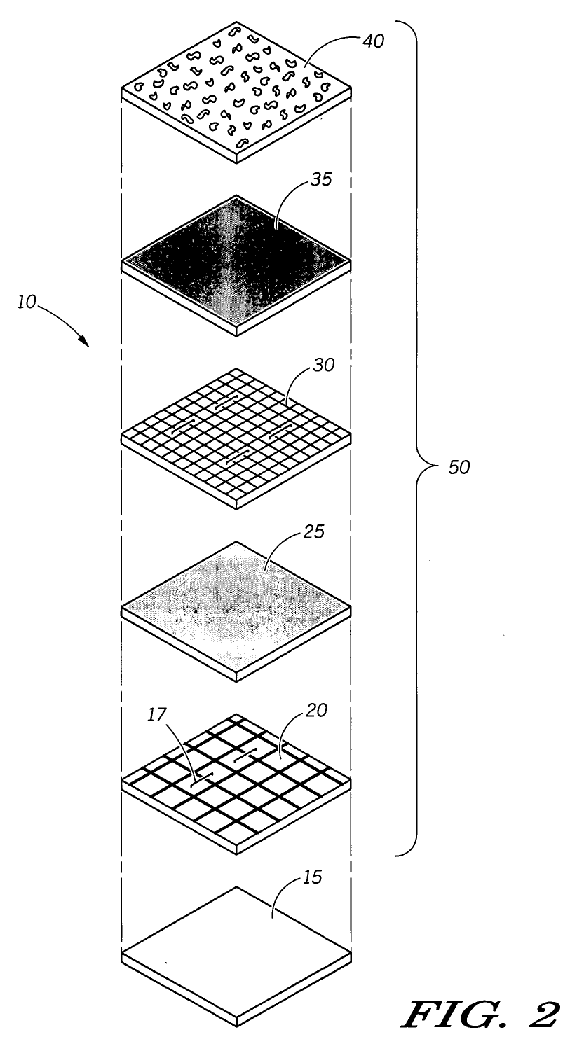

As illustrated in FIG. 2, the two scrim layers 20, 30 and the two skimcoat layers 25, 35 collectively form a system 50 for reinforcing the wallboard 15. The reinforcement system 50 is preferably applied or attached to the wallboard 15 on-site, after the wallboard 15 has been installed to form the wall or ceiling of a building. Alternatively, the reinforcement system 50 may be applied or attached to the wallboard prior to installation of the composite wallboard and reinforcement system. In the alternative case, joint or spackling compound may be required to cover and/or repair holes and/or chips created by the use of fasteners, such as screws, to attach the composite wallboard and reinforcement system to the studs, furring strips, plywood or other framing materials of the building.

If desired, a finishing layer 40 may be applied to and disposed on the second skimcoat layer 35 to provide a durable decorative finish to the reinforced wallboard 15. The finishing layer 40 preferably comprises an acrylic coating, such as the DURPOLEX textured acrylic coating that is commercially available from Triarch Industries, Inc. of Houston, Tex. Alternatively, the finishing layer 40 may comprise a lime and ground marble based plaster finish, such as the SPATULA STUHHI Venetian plaster system that is also commercially available from Triarch Industries, Inc. of Houston, Tex. Still further, various other finishing materials, such as paint, plaster, tile, wallpaper, paneling, and other materials, may be used in accordance with known techniques to form the finishing layer 40. The finishing layer 40 is preferably disposed on the second skimcoat layer 35 after both skimcoat layers 25, 35 have completely dried or set (approximately eight hours depending on the physical properties of the materials selected to form the two skimcoat layers 25, 35).

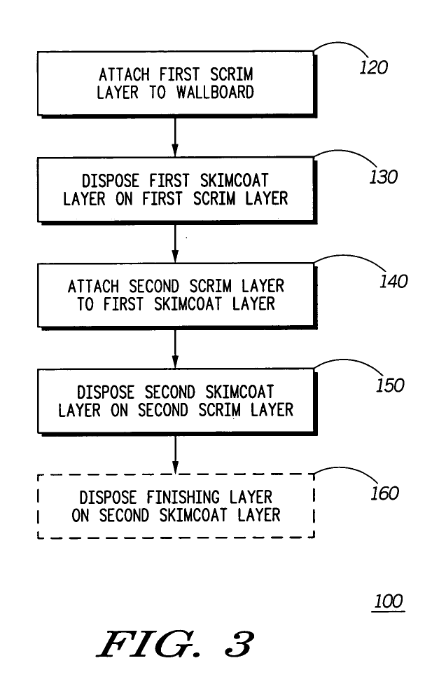

Referring now to FIG. 3, a flow chart 100 of steps for reinforcing wallboard used to form a wall or ceiling of a building is provided in accordance with a preferred embodiment of the present invention. The process begins when a first scrim layer is attached (120) to a surface of the wallboard preferably, although not exclusively, using a set of fasteners. Next, a first skimcoat layer is disposed on (130) the first scrim layer using a trowel or other appropriate applicator. The first skimcoat layer is allowed to at least partially dry for a period of time (e.g., eight hours), after which a second scrim layer is attached (140) to the first skimcoat layer preferably, although not exclusively, using a set of fasteners.

A second skimcoat layer is then disposed on (150) the second scrim layer using the trowel or other applicator. Finally, preferably after both skimcoat layers have completely dried or set (e.g., about 16 hours), a finishing layer is optionally disposed on (160) the second skimcoat layer to provide a decorative finish to the reinforced wallboard. Once the finishing layer has fully dried and or set,.the reinforced wallboard is ready for use.

The present invention encompasses a system and method for reinforcing wallboard used to form a wall or ceiling of a building. With this invention, entire wall and/or ceiling surfaces may be reinforced to sustain commercial environments without requiring a substantial amount of time before being ready for use. In addition, the present invention facilitates reinforcement of wallboard regardless of whether the wallboard is in need of repair and may be used with any type of wallboard. Thus, in contrast to prior art reactive wallboard repair techniques, the present invention provides a proactive system for reinforcing wallboard such that the reinforced wallboard can withstand the demands of commercial environments.

It should be noted that the drawings are not necessarily to scale and that the embodiments are sometimes illustrated by graphic symbols, phantom lines, diagrammatic representations, and fragmentary views. In certain instances, details that are not necessary for an understanding of the present invention or that render other details difficult to perceive may have been omitted.

In the foregoing specification, the present invention has been described with reference to specific embodiments. However, one of ordinary skill in the art will appreciate that various modifications and changes may be made without departing from the spirit and scope of the present invention as set forth in the appended claims. For example, while two scrim and skimcoat formulated reinforcement layers are disclosed herein to form the preferred reinforcement system of the present invention, additional such reinforcement layers may be added to the wallboard to further strengthen and reinforce the wallboard. Accordingly, the specification and drawings are to be regarded in an illustrative rather than a restrictive sense, and all such modifications are intended to be included within the scope of the present invention.

Benefits, other advantages, and solutions to problems have been described above with regard to specific embodiments of the present invention. However, the benefits, advantages, solutions to problems, and any element(s) that may cause or result in such benefits, advantages, or solutions to become more pronounced are not to be construed as a critical, required, or essential feature or element of any or all the claims. As used herein and in the appended claims, the terms “comprises,” “comprising” or any other variation thereof is intended to refer to a non-exclusive inclusion, such that a process, method, apparatus, or article of manufacture that comprises a list of elements does not include only those elements in the list, but may include other elements not expressly listed or inherent to such process, method, apparatus, or article of manufacture.

1. A composite material for use in forming a wall or ceiling of a building, the composite material comprising:
a section of wallboard having two surfaces separated by a thickness;
a first reinforcement layer attached to a first surface of the wallboard, the first reinforcement layer including a first scrim layer and a first skimcoat layer disposed on the first scrim layer; and
a second reinforcement layer attached to the first reinforcement layer, the second reinforcement layer including a second scrim layer and a second skimcoat layer disposed on the second scrim layer.

2. The composite material of claim 1, further comprising:
a finishing layer disposed on the second reinforcement layer.

3. The composite material of claim 2, wherein the finishing layer comprises at least one of plaster, paint, acrylic coating, wallpaper, paneling, and tile.

4. The composite material of claim 1, wherein the wallboard comprises drywall.

5. The composite material of claim 1, further comprising at least one fastener that attaches the first reinforcement layer to the section of wallboard.

6. The composite material of claim 5, wherein the at least one fastener comprises at least one staple.

7. The composite material of claim 1, further comprising at least one fastener that attaches the second reinforcement layer to the first reinforcement layer.

8. The composite material of claim 1, wherein at least one of the first and second scrim layers comprises fiberglass.

9. The composite material of claim 1, wherein each of the first scrim layer and the second scrim layer includes a plurality of yarns in a cross-hatched pattern and wherein widths of yams forming rows and columns of the first scrim layer are greater than widths of yams forming rows and columns of the second scrim layer.

10. The composite material of claim 1, wherein the first scrim layer is fabricated from a first material and the second scrim layer is fabricated from a second material.

11. A system for reinforcing wallboard used to form a wall or ceiling of a building, the system comprising:
a first reinforcement layer attached to a surface of the wallboard, the first reinforcement layer including a first scrim layer and a first skimcoat layer disposed on the first scrim layer; and
a second reinforcement layer attached to the first reinforcement layer, the second reinforcement layer including a second scrim layer and a second skimcoat layer disposed on the second scrim layer.

12. The system of claim 11, further comprising:
a finishing layer disposed on the second reinforcement layer.

13. The system of claim 12, wherein the finishing layer comprises at least one of plaster, paint, acrylic coating, wallpaper, paneling, and tile.

14. The system of claim 11, further comprising at least one fastener that attaches the first reinforcement layer to the surface of the wallboard.

15. The system of claim 14, wherein the at least one fastener comprises at least one staple.

16. The system of claim 11, further comprising at least one fastener that attaches the second reinforcement layer to the first reinforcement layer.

17. The system of claim 11, wherein at least one of the first and second scrim layers comprises nylon, plastic, fiberglass, or steel.

18. The system of claim 11, wherein each of the first scrim layer and the second scrim layer includes a plurality of yarns in a cross-hatched pattern and wherein widths of yarns forming rows and columns of the first scrim layer are greater than widths of yarns forming rows and columns of the second scrim layer.

19. The system of claim 12, wherein the first scrim layer is fabricated from a first material and the second scrim layer is fabricated from a second material.

20. A method for reinforcing wallboard used to form a wall or ceiling of a building, the method comprising:
attaching a first scrim layer to a surface of the wallboard;
disposing a first skimcoat layer on the first scrim layer;
attaching a second scrim layer to the first skimcoat layer; and
disposing a second skimcoat layer on the second scrim layer.

21. The method of claim 20, further comprising disposing a finishing layer on the second skimcoat layer.
